(19) United States
(12) Patent Application Publication
(10) Pub. No.: US 2015/0142561 A1
(43) Pub. Date: May 21, 2015

(54) METHOD AND SYSTEM FOR DELIVERY OF CONTENT BASED ON DATA CAPTURED THROUGH TRANSIT PAYMENTS

(71) Applicant: MasterCard International Incorporated, Purchase, NY (US)

(72) Inventors: Jean-Pierre GERARD, Croton-On-Hudson, NY (US); Po HU, Norwalk, CT (US); Arun ELANGOVAN, Astoria, NY (US)

(73) Assignee: MasterCard International Incorporated, Purchase, NY (US)

(21) Appl. No.: 14/082,746

(22) Filed: Nov. 18, 2013

(51) Int. Cl. G06Q 30/02

(52) U.S. Cl. CPC G06Q 30/0261; G06Q 30/0255
USPC 705/14.53

(57) ABSTRACT

A method for distributing targeted content includes: storing content profiles, each including a content item and selection criteria; storing account profiles, each including data related to an account including an account identifier and transaction data entries including transaction data corresponding to a transaction involving the account; storing consumer profiles, each including an account number and transit identifier; receiving a transaction notification corresponding to a transportation transaction involving a consumer and including a specific transit identifier; identifying a specific consumer profile where the included transit identifier corresponds to the specific transit identifier; identifying a specific account profile where the account identifier corresponds to the account number of the specific consumer profile; identifying a specific content profile based on the included selection criteria and the transaction data of the transaction data entries of the specific account profile; and transmitting the content item of the specific content profile for distribution to the consumer.

### FIELD

The present disclosure relates to the delivery of targeted content based on data captured through transit payments, specifically the identification of a consumer location based on a transportation-related transaction and use thereof for delivering targeted content to the consumer.

### BACKGROUND

Many entities, such as merchants, manufacturers, retailers, offer providers, advertisers, and others, use advertising and content display (e.g., coupons, offers, deals, etc.) in an effort to entice consumers to purchase specific products or services or to engage in commerce with a particular merchant or business. In order to increase the effectiveness of such content distribution, many entities identify content that is specifically targeted for a consumer based on information available about the consumer. For example, a merchant may identify the interests of a consumer, based on a survey, past purchases, social network information, etc., and may then select advertisements to display to the consumer based on their interests.

However, such targeting techniques may enable a merchant to identify a target type of consumer, but may not be beneficial in attempting to geographically locate the consumers that fit a targeting profile. In an effort to identify these consumers, some methods and systems have been developed for identifying a consumer's geographic location. Some such methods include identifying the geographic location of a mobile device associated with a consumer. However, consumers may not always be in possession of their mobile device, their mobile device may lack service, or a consumer may be unwilling to share the location of their device for use by a third party, such as an advertiser of offer provider.

Thus, there is a need for a technical solution to identify the geographic location of a consumer, without requiring the use of a mobile communication device, as a factor (potentially along with additional consumer data) for the delivery of targeted content to a consumer.

### SUMMARY

The present disclosure provides a description of systems and methods for distributing targeted content to a consumer.

A method for distributing targeted content to a consumer includes: storing, in a content database, a plurality of content profiles, wherein each content profile includes data relating to content for distributing including at least a content item and one or more selection criteria; storing, in an account database, a plurality of account profiles, wherein each account profile includes data related to a payment account including at least an account identifier and a plurality of transaction data entries, each transaction data entry including transaction data corresponding to a payment transaction involving the related payment account; storing, in a consumer database, a plurality of consumer profiles, wherein each consumer profile includes data related to a consumer including at least an account number and a transit identifier; receiving, by a receiving device, a transaction notification, wherein the transaction notification corresponds to a transportation-related payment transaction involving a consumer and includes at least a specific transit identifier and a geographic location; identifying, in the consumer database, a specific consumer profile where the included transit identifier corresponds to the specific transit identifier; identifying, in the account database, a specific account profile where the included account identifier corresponds to the account number included in the specific consumer profile; identifying, in the content database, a specific content profile based on the included one or more selection criteria and at least the transaction data included in the plurality of transaction data entries included in the specific account profile; and transmitting, by a transmitting device, at least the content item included in the specific content profile for distribution to the consumer.

A system for distributing targeted content to a consumer includes a content database, an account database, a consumer database, a receiving device, and a transmitting device. The content database is configured to store a plurality of content profiles, wherein each content profile includes data relating to content for distributing including at least a content item and one or more selection criteria. The account database is configured to store a plurality of account profiles, wherein each account profile includes data related to a payment account including at least an account identifier and a plurality of transaction data entries, each transaction data entry including transaction data corresponding to a payment transaction involving the related payment account. The consumer database is configured to store a plurality of consumer profiles, wherein each consumer profile includes data related to a consumer including at least an account number and a transit identifier. The receiving device is configured to receive a transaction notification, wherein the transaction notification corresponds to a transportation-related payment transaction involving a consumer and includes at least a specific transit identifier and a geographic location. The processing device is configured to: identify, in the consumer database, a specific consumer profile where the included transit identifier corresponds to the specific transit identifier; identify, in the account database, a specific account profile where the included account identifier corresponds to the account number included in the specific consumer profile; and identify, in the content database, a specific content profile based on the included one or more selection criteria and at least the transaction data included in the plurality of transaction data entries included in the specific account profile. The transmitting device is configured to transmit at least the content item included in the specific content profile for distribution to the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for distributing targeted content to a consumer based on data captured through transit payments in accordance with exemplary embodiments.

FIG. 2 is a block diagram illustrating the processing server of FIG. 1 for the identification of targeted content based on data captured through transit payments in accordance with exemplary embodiments.

FIG. 3 is a flow diagram illustrating a process for the selecting and distribution of targeted content using the exemplary system of FIG. 1 in accordance with exemplary embodiments.

FIG. 4 is a flow diagram illustrating a method for the identification and distribution of targeted content by the processing server of FIG. 1 in accordance with exemplary embodiments.

FIG. 5 is a flow chart illustrating an exemplary method for distributing targeted content to a consumer in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or other computer). For example, in some instances, data including a payment account number may be considered a payment card for the processing of a transaction funded by the associated payment account. In some instances, a check may be considered a payment card where applicable.

### System for Distributing Targeted Content Based on Transit Payment Data

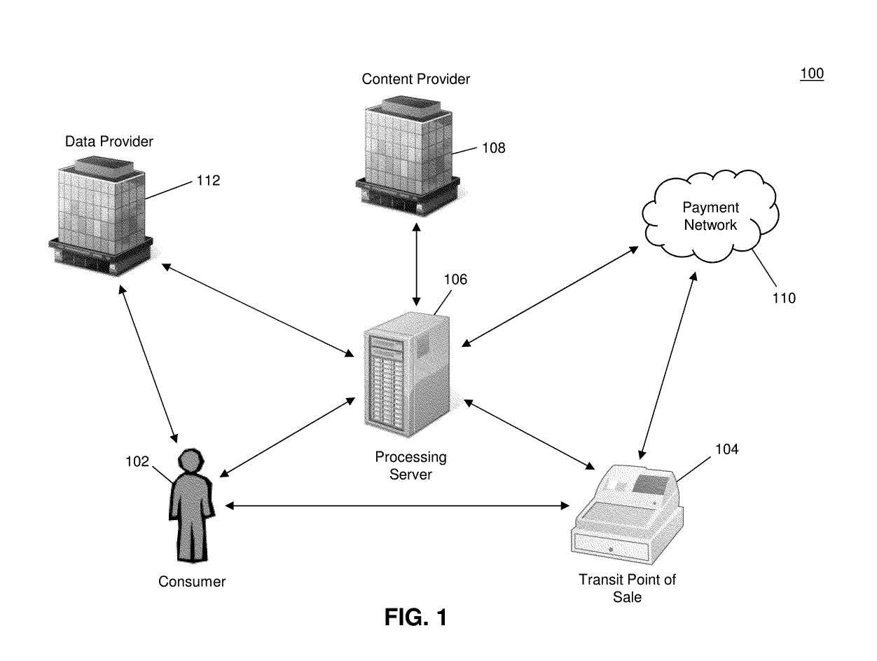

FIG. 1 illustrates a system 100 for the distribution of targeted content to a consumer based on data captured through transit payments made by the consumer.

The system 100 may include a consumer 102. The consumer 102 may have an account with a transit services (e.g., trains, planes, ferries, toll roads, toll bridges toll tunnels, subways, etc.) entity (not pictured), such as a transit authority, department of transportation, transportation company, etc. The transit services entity may operate one or more transit points of sale 104. The transit point of sale 104 may be a tollbooth, turnstile, checkpoint, gate, or other suitable point of sale at which the consumer 102 may transact as part of use of services offered by the transit services entity. For example, the transit point of sale 104 may be a turnstile at the point of ingress or egress for a train system or may be a tollbooth or electronic toll-collection system located on a toll road, or other similar structures to initiate payment for the cost of using the transportation facility geographically located at the facility.

The consumer 102 may engage in a transportation-related payment transaction at the transit point of sale 104. The transaction may be processed by a payment network 110 using systems and methods that will be apparent to persons having skill in the relevant art for the processing of payment transactions. The transaction may be made using a transit account the consumer 102 has established with the transit services entity or a payment account (collectively referred to as a “transit account” herein). The transit account may be associated with an account identifier (e.g., a transit identifier) and one or more payment accounts corresponding to the consumer 102.

The consumer 102 may present the associated transit identifier to the transit point of sale 104 (e.g., using a card encoded with the identifier, a transmitter encoded with the identifier or used to transmit a signal encoded with the identifier, displaying or providing printed indicia that is machine readable, or nearly any mechanism that can convey the transit identifier to the transit point of sale 104). The transit point of sale 104 may (e.g., in communication with one or more networks or other devices) identify the account corresponding to the consumer 102 using the identifier and process the transaction accordingly, such as by using credit on the account, by using the payment account information for payment of the transaction, or by using the payment account directly. The payment account may be in the form of a virtual card number that has associated controls, such as being limited in use for transportation, over certain periods of time for certain amounts in certain geographic locations, etc., as appropriate, that can be the consumer's real account number or a stand-in number such as an controlled payment number.

That is, the transit point of sale might require use of a transit identifier that relates to a transit account that identifies a payment method and payment account, and potentially other information about the consumer, or might be able to process a payment transaction directly from a payment card (e.g., the normal authorization process for use of a payment account). Herein, the transit “identifier” encompasses both embodiments, though of course if the payment card authorization originates directly from the transit point of sale, intermediate steps that involve the transit account may not necessarily be required.

Once the transaction has been processed, the transit point of sale 104 (e.g., or the transit services entity associated with the transit point of sale 104) may transmit a notification of the transaction to a processing server 106. The transaction notification may include at least the transit identifier and a geographic location. The geographic location may be a geographic location associated with the transit point of sale 104, such as geographic coordinates, a street address, a zip code, a name, etc. The processing server 106, discussed in more detail below, my receive the transaction notification and identify a consumer profile associated with the transit account using the transit identifier. In some circumstances, the transit point of sale will indicate the travel path of the consumer (e.g., a toll both on one side of a toll road), and in other instances indicate a usually limited number alternative paths (e.g., a turnstile at a subway near a consumers home). In the latter case, the consumer profile might help indicate which path is likely, such as from prior exits from the subway, or other prior transactions (either transit related or using an payment card associated with the consumer within a time frame and geographic region of earlier travels on the same transport facility (e.g., recurrent transactions that tend to identify the destination such as near the persons place of work).

The processing server 106 may be configured to identify content for distribution to the consumer 102 based on consumer data and the geographic location included in the transaction notification. The content may be provided by a content provider 108, such as a merchant, manufacturer, retailer, offer provider, advertiser, etc. The content may include offers, deals, coupons, advertisements, discounts, etc. and may be formatted in any suitable type of format, such as for delivery via e-mail, short message service message, multimedia message service message, webpage, etc. The processing server 106 may store content received from the content provider 108 and identify content to distribute to the consumer 102 based on the geographic location of the transit point of sale 104 and transaction data associated with the consumer 102.

The transaction data may be provided to the processing server 106 from the payment network 110, the transit services entity, and/or any other suitable entity or service. The transaction data may be comprised of a plurality of transaction data entries, each entry related to a unique payment transaction. The transaction data included in each transaction data entry may include at least a payment account identifier corresponding to the payment account used to fund the corresponding payment transaction. The processing server 106 may identify transaction data entries including a payment account identifier corresponding to the consumer 102 by identifying the payment account identifier associated with the consumer's transit account, using the received transit identifier.

The processing server 106 may identify the content to be distributed based on the transaction data included in the transaction data entries associated with the consumer 102, and then distribute the content to the consumer 102. The content may be distributed in a manner consistent with the format of the identified content and, in some instances, may be based on preferences of the consumer 102. For example, the consumer 102 may prefer to receive offers via short message service (SMS) message on a mobile device. In such an example, the processing server 106 may identify content for distribution via SMS message and transmit the identified content to a mobile device associated with the consumer 102 accordingly.

In some embodiments, the processing server 106 may be further configured to identify content for distribution based on additional consumer data. The additional consumer data may be provided by one or more data providers 112. The data providers 112 may be configured to gather data associated with the consumer 102 from the consumer 102 or other sources. The consumer data may include demographic data, advertising data, offer data, and consumer-supplied data. In some embodiments, the consumer data may not include any personally identifiable data. The data provider 112 may identify the consumer data using the transit identifier, payment account identifier, or other suitable information, and may provide the consumer data associated with the consumer 102 to the processing server 106. The processing server 106 may then use the consumer data in addition to the transaction data and geographic location to identify content for distribution.

The system 100 may provide for the distribution of content to a consumer 102 that is targeted to the consumer 102 and based on at least transaction data and a geographic location of the transit point of sale 104, and potentially the likely or determined travel path of the consumer 102. By using the transit point of sale 104, the processing server 106 may be able to quickly identify both the current geographic location of the consumer 102 and likely travel path of the consumer 102 as well as previous transaction history of the consumer 102, while being capable of maintaining a high level of consumer privacy and security. The location data gathered by the processing server 106 may also be aggregated in order to identify movement patterns of the consumer 102 to identify a location where the consumer 102 may be headed, and putative travel path as mentioned before.

For example, the processing server 106 may receive a notification of the consumer 102 entering a subway system at a first stop, and then exiting the system at a second stop, indicating the consumer's destination to be in near the second stop. The processing server 106 can thus identify content for distribution associated with the location of the second stop. This may result in the identification of content that is more effective than content identified using mobile device geographic locations, from which a point of destination of a consumer may be more difficult to identify.

### Processing Server

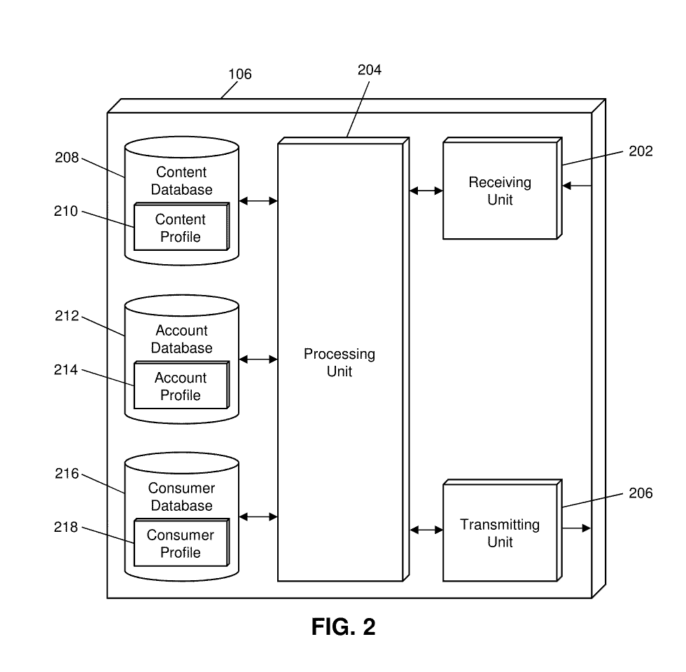

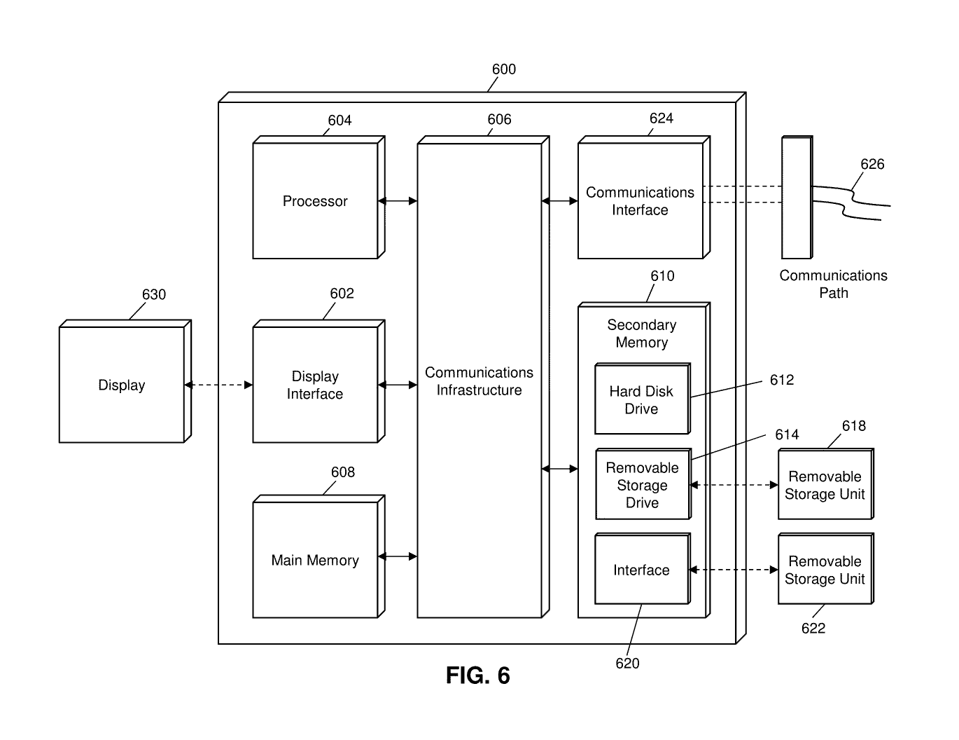

FIG. 2 illustrates an embodiment of the processing server 106 of the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 600 illustrated in FIG. 6 and discussed in more detail below may be a suitable configuration of the processing server 106.

The processing server 106 may include a receiving unit 202. The receiving unit 202 may be configured to receive data over one or more networks via one or more network protocols. The receiving unit 202 may be configured to receive content data from the content provider 108. The content data may include at least one content item to be distributed and one or more selection criteria for use in identifying content to be distributed. The processing server 106 may further include a processing unit 204. The processing unit 204 may be configured to store the received content data in a content database 208 as a plurality of content profiles 210. Each content profile may include at least one content item and the corresponding one or more selection criteria.

The receiving unit 202 may also receive transaction data from the payment network 110. The processing unit 204 may be configured to store the received transaction data in an account database 212 as a plurality of account profiles 214. Each account profile 214 may be related to a payment account and include an account identifier associated with the related payment account and a transaction data entry for each payment transaction funded using the related payment account. The transaction data entries may include transaction data corresponding to the payment transaction, such as a transaction amount, transaction time and/or date, merchant data, product data, etc.

The receiving unit 202 may also be configured to receive transit account information from the transit services entity. The transit account information may include the transit identifier and corresponding payment account information for a plurality of consumers that are registered with the transit services entity. The processing unit 204 may be configured to store the transit account information in a consumer database 216 as a plurality of consumer profiles 218. Each consumer profile 218 may include the transit identifier and corresponding payment account number or identifier for a unique consumer 102.

In some embodiments, the receiving unit 202 may be further configured to receive consumer data from the data provider 112. The processing server 106 may be configured to store the received consumer data in the account profile 214 and/or consumer profile 218 related to the consumer 102 with whom the consumer data is associated.

The receiving unit 202 may be further configured to receive a transaction notification. The transaction notification may correspond to a transportation-related payment transaction involving a consumer 102 and include the transit identifier associated with the consumer 102 and a geographic location associated with the transit point of sale 104 used in the payment transaction. The processing unit 204 may be configured to identify a consumer profile 218 associated with the consumer 102 using the transit identifier. The processing unit 204 may also be configured to identify an account profile 214 corresponding to the account identifier included in the identified consumer profile 218.

In embodiments where the transit point of sale 104 (e.g., and by extension, the transit services entity) may process transit-related payment transactions directly using a payment account associated with the consumer 102 (e.g., and not via a transit identifier), the transaction notification may include the account identifier associated with the payment account. In such an embodiment, the processing unit 204 may directly identify the account profile 214 without the use of a consumer profile 218. In some embodiments, the transit identifier for a consumer 102 may be the same as the account identifier.

The processing unit 204 may be further configured to identify a content profile 210 stored in the content database 208 based on the included one or more selection criteria and the transaction data included in the transaction data entries of the identified account profile 214. In some embodiments, the content profile 210 identified may be further based on the geographic location in the transaction notification and/or additional consumer data stored in the account profile 214 and/or the consumer profile 218.

The processing server 106 may further include a transmitting unit 206. The transmitting unit 206 may be configured to transmit data over one or more networks via one or more network protocols. The transmitting unit 206 may be configured to transmit the content item included in the identified content profile 210 to the consumer 102 via one or more methods as will be apparent to persons having skill in the relevant art. In some instances, the method for distribution may be identified in the consumer profile 218 and/or the account profile 214 associated with the consumer 102 and identified by the processing unit 204.

In some embodiments, the transmitting unit 206 may also be configured to transmit requests for data to an outside entity, such as the transit services entity, the payment network 110, the content provider 108, and the data provider 112. For example, the transmitting unit 206 may transmit a request for consumer data to the data provider 112, the request for consumer data including an identifier associated with the consumer 102 for use by the data provider 112 in identifying consumer data, such as the account identifier or transit identifier.

In some embodiments, the processing unit 204 may be configured to aggregate and store historical data in one or more of the databases 208, 212, and 216. For example, the processing unit 204 may store geographic locations included in received transaction notifications in the consumer profile 218. The processing unit 204 may also store corresponding times and/or dates when the geographic locations are identified, such as to identify movement behaviors and other metrics, which may be used by the processing unit 204 in the identification of content to be distributed to the consumer 102. Additional data that may be aggregated and stored by the processing unit 204 and used for the identification of targeted content will be apparent to persons having skill in the relevant art.

### Process for Distributing Targeted Content Based on Transit Data

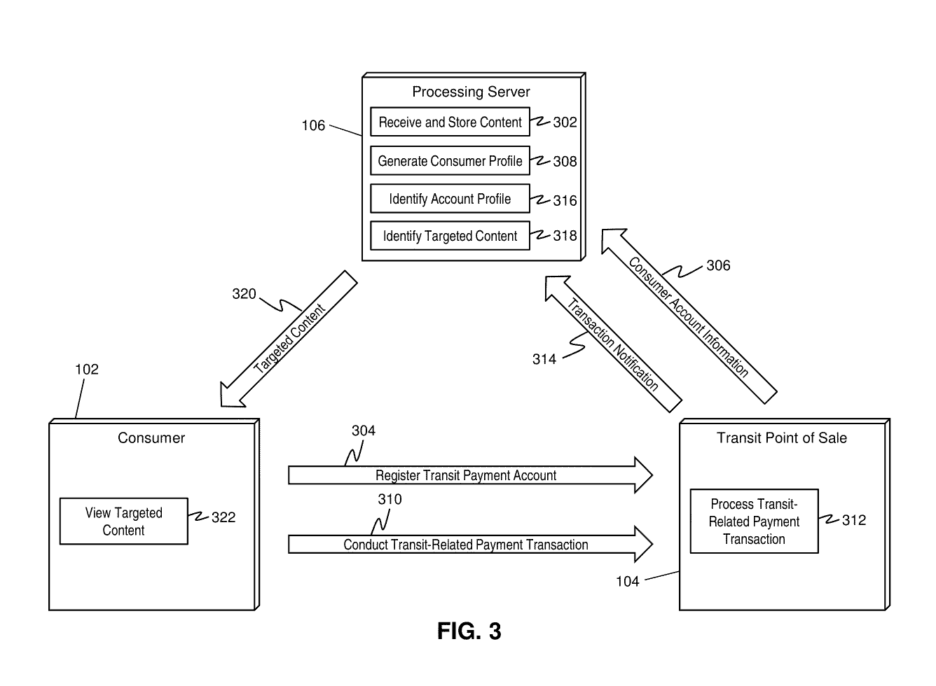

FIG. 3 illustrates a process for the distribution of targeted content to the consumer 102 based on a transportation-related payment transaction involving the consumer 102 and the transit point of sale 104.

In step 302, the processing server 106 may receive content from the content provider 108 and may store the received content in the content database 208 as a plurality of content profiles 210, as discussed above. Each content profile 210 may include at least one or more selection criteria and at least one content item. In step 304, the consumer 102 may register an account with the transit services entity (e.g., via the transit point of sale 104). Registration of the account may include identification of a transit identifier for use by the consumer 102 in conducting payment transactions at the transit point of sale 104 and the providing of payment account details by the consumer 102 for use in funding the conducted payment transactions.

In step 306, the transit services entity may forward the consumer transit account information to the processing server 106. The processing server 106 may receive the information, and, in step 308, generate a consumer profile 218 for storage in the consumer database 216 including the consumer transit identifier and corresponding payment account details. In step 310, the consumer 102 may conduct a transit-related payment transaction at the transit point of sale 104. For example, the consumer 102 may pass a tollbooth that identifies the consumer 102 using the consumer identifier. In step 312, the transit point of sale 104 may process the transit-related payment transaction using the transit account (e.g., funded by the corresponding payment account or directly using the payment account, as necessary) using methods and systems that will be apparent to persons having skill in the relevant art.

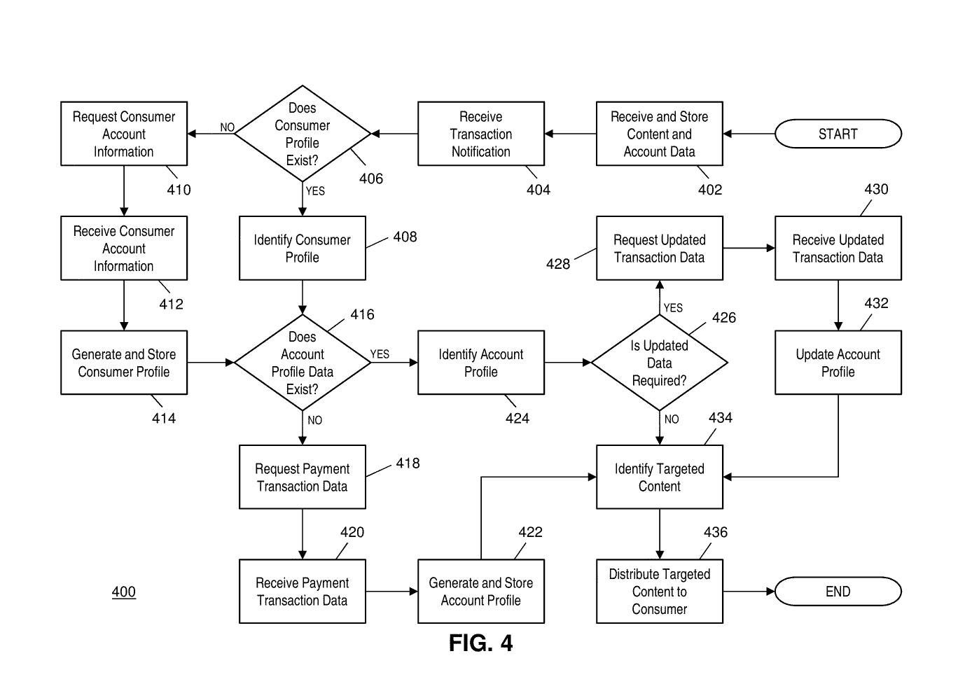

In step 314, the transit point of sale 104 (e.g., or the transit services entity) may transmit a transaction notification to the processing server 106 notifying the processing server 106 of the completed transit-related payment transaction. The transaction notification may include the transit identifier associated with the consumer 102 and the geographic location of the transit point of sale 104. As discussed in more detail below with respect to FIG. 4, in step 316, the processing server 106 may identify an account profile 214 associated with the consumer 102 via the transit identifier, and, in step 318, identify a content profile 210 based on the transaction data included in the account profile 214.

In step 320, the processing server 106 may transmit the content item or items included in the identified content profile 210 to the consumer 102 via methods that will be apparent to persons having skill in the relevant art. For instance, the advertising can be provided to the consumer 102, during or after the travel through nearly any media outlet, such as displays located on or around the transport facility, on mobile computing devices (e.g., mobile phone, tablet computer, laptop computer, etc.), personal radio, desktop computers during times other than travel times, and nearly any other media outlet that might be accessible to the consumer or segment or micro segment of consumers targeted for delivery of the identified content. In step 322, the consumer 102 may view the distributed targeted content. In some embodiments, the processing server 106 may obtain information regarding the consumer's viewing of the targeted content, such as consumer feedback, and indication of viewing, an indication of acceptance and/or use of a distributed offer, and other additional data that will be apparent to persons having skill in the relevant art.

### Method for Identifying and Distributing Targeted Content

FIG. 4 illustrates a method 400 for the identification of targeted content and distribution thereof to the consumer 102 by the processing server 106. In some instances, the method 400 may be executed as part of the process illustrated in FIG. 3 as will be apparent to persons having skill in the relevant art.

In step 402, the receiving unit 202 of the processing server 106 may receive content data from the content provider 108 to be stored in the content database 208, and transit account data from the transit service entity to be stored in the consumer database 216. In step 404, the receiving unit 202 may receive a transaction notification corresponding to a transit-related payment transaction involving a consumer 102 from the transit service entity including a transit identifier and a geographic location. In step 406, the processing unit 204 may determine if a consumer profile 218 exists in the consumer database 216 corresponding to the consumer 102. The determination may be based on the identification of any consumer profile 218 is stored in the consumer database 216 where the included transit identifier corresponds to the transit identifier included in the received transaction notification.

If a consumer profile 218 does exist, then the processing unit 204 may identify the corresponding consumer profile 218 using the transit identifier. If no consumer profile 218 exists, then, in step 410, the transmitting unit 206 of the processing server 106 may transmit a request for consumer transit account information to the transit services entity. In step 412, the receiving unit 202 may receive consumer transit account information including the payment account identifier associated with the consumer's transit account from the transit services entity. In step 414, the processing unit 204 may generate a new consumer profile 218 corresponding to the consumer 102 including the transit identifier and payment account identifier and store the newly generated consumer profile 218 in the consumer database 216.

Once a consumer profile 218 corresponding to the consumer 102 has been identified and/or generated, then, in step 416, the processing unit 204 may determine if an account profile 214 exists that corresponds to the consumer 102. The determination may be based on the identification of any account profile 214 stored in the account database 212 where the account identifier corresponds to the account identifier of the identified consumer profile 218.

If an account profile 214 does not exist, then, in step 418, the transmitting unit 206 may transmit a request for payment transaction data to the payment network 110. The request may include the account identifier that corresponds to the payment account of the consumer 102 as included in the identified consumer profile 218. The payment network 110 may identify payment transaction data for payment transactions funded using the corresponding payment account, which may be returned to the processing server 106 and received by the receiving unit 202, in step 420. In step 422, the processing unit 204 may generate an account profile 214 included transaction data entries for each of the payment transactions included in the received transaction data, and store the generated account profile 214 in the account database 212.

If an account profile 214 does exist, then, in step 424, the processing unit 204 may identify the corresponding account profile 214 using the account identifier. In step 426, the processing unit 204 may determine if the identified account profile 214 requires updating. Updating may be required by the processing server 106, the content provider 108, or other entity and/or service such that the most recent, and thereby potentially more effective, transaction data is used to identify targeted content for distribution to the consumer 102. Criteria for requiring an update to consumer transaction data will be apparent to persons having skill in the relevant art. In some instances, consumer transaction data may be updated at regular intervals.

If updating of the account profile 214 is required, then, in step 428, the transmitting unit 206 may transmit a request for updated transaction data to the payment network 110, the request including the account identifier for the corresponding payment account. In step 430, the receiving unit 202 may receive the updated transaction data, which may include transaction data for payment transactions involving the consumer 102 (e.g., based on the account identifier) conducted since the previous update. In step 432, the processing unit 204 may update the account profile 214 to include additional transaction data entries based on the updated transaction data.

Once an account profile 214 has been identified, and generated and/or updated as necessary, then, in step 434, the processing unit 204 may identify a content profile 210 in the content database based on the included one or more selection criteria and the transaction data included in the transaction data entries of the account profile 214. The identification of the content profile 210 may be further based on the geographic location included in the received transaction notification. In some embodiments, selection of the content profile 210 may be further based on consumer data included in the consumer profile 218 and/or the account profile 214, such as consumer data provided by the data provider 112. In one embodiment, the one or more selection criteria included in each content profile 210 may be a model score. In such an embodiment, the processing unit 204 may calculate a consumer score based on the transaction data (e.g., and other additional data) for the consumer 102. The processing unit 204 may then identify the content profile 210 based on correspondence between the included model score and the calculated consumer score.

In some instances, the processing unit 204 may calculate multiple consumer scores. For example, the processing unit 204 may calculate a consumer score for each of a plurality of criteria, such as offer redemption propensities, propensities regarding specific merchants, products, or industries, weighted demographics scores, etc. In such an instance, each content profile 210 may include a model score corresponding to each calculated consumer score. The processing unit 204 may then identify a content profile 210 based on correspondence between each model score and the corresponding consumer score. In some embodiments, scoring rules and/or algorithms may be stored in a memory of the processing server 106. Additional methods suitable for selection a content profile 210 based on transaction data for a consumer 102 will be apparent to persons having skill in the relevant art.

Once the content profile 210 has been identified, then, in step 436, the transmitting unit 206 may transmit the included content item to the consumer 102. In some embodiments, the consumer profile 218 and/or account profile 214 may include a preferred method of distribution, such as e-mail, SMS message, webpage advertisement, etc. or nearly any other media outlet accessible to the consumer 102. In such an embodiment, the transmitting unit 206 may transmit the content item to the consumer 102 using the preferred method of distribution. In some instances, the content item may be distributed in real-time or near real-time following the transit-related payment transaction at the transit point of sale 104. In other instances, the content item may be distributed at an appropriate time thereafter. For example, the content item may be distributed as a webpage advertisement associated with the travels of the consumer (e.g., restaurants near the identified entry, adjacent or ending of an identified travel path) to the consumer 102 the next time the consumer 102 visits a specific webpage, such as a webpage of the transit services entity used to manage the consumer's transit account. Additional methods for distribution of a content item to a consumer 102 will be apparent to persons having skill in the relevant art.

### Exemplary Method for Distributing Targeted Content to a Consumer

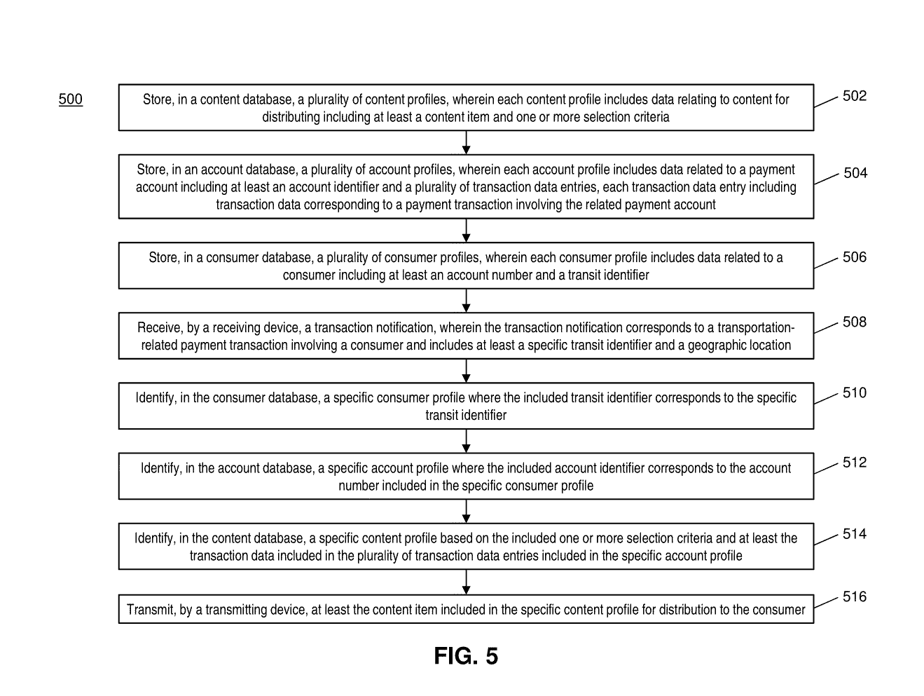

FIG. 5 illustrates an exemplary method 500 for the distribution of targeted content to a consumer based on captured transit data.

In step 502, a plurality of content profiles (e.g., the content profiles 210) may be stored in a content database (e.g., the content database 208), wherein each content profile 210 includes data relating to content for distributing including at least a content item and one or more selection criteria. In one embodiment, the content item may be at least one of: an advertisement, offer, deal discount, or coupon for a good or service. In another embodiment, the content item may be at least one of: an e-mail, a short message service message, a multimedia message service message, and a digital image or video. In some embodiments, the one or more selection criteria may include an associated geographic location.

In step 504, a plurality of account profiles (e.g., the account profiles 214) may be stored in an account database (e.g., the account database 212), wherein each account profile 214 includes data related to a payment account including at least an account identifier and a plurality of transaction data entries, each transaction data entry including transaction data corresponding to a payment transaction involving the related payment account. In one embodiment, each account profile 214 may further include at least one of: demographic data, advertising data, offer data, and account-holder supplied data. In an exemplary embodiment, each account profile 214 may not include any personally identifiable data.

In step 506, a plurality of consumer profiles (e.g., the consumer profiles 218) may be stored in a consumer database (e.g., the consumer database 216), wherein each consumer profile 218 includes data related to a consumer (e.g., the consumer 102) including at least an account number and a transit identifier. In step 508, a transaction notification may be received, by a receiving device (e.g., the receiving unit 202), wherein the transaction notification corresponds to a transportation-related payment transaction involving a consumer 102 and includes at least a specific transit identifier and a geographic location.

In step 510, a specific consumer profile 218 may be identified, in the consumer database 216, where the included transit identifier corresponds to the specific transit identifier. In step 512, a specific account profile 214 may be identified, in the account database 212, where the included account identifier corresponds to the account number included in the specific consumer profile 218.

In step 514, a specific content profile 210 may be identified, in the content database 208, based on the included one or more selection criteria and at least the transaction data included in the plurality of transaction data entries included in the specific account profile 214. In one embodiment, the identified specific content profile 210 may be further based on the geographic location included in the received transaction notification.

In some embodiments, the one or more selection criteria included in each content profile 210 may include at least one model score. In such an embodiment, identifying the specific content profile may further include: identifying, based on at least the transaction data included in each transaction data entry included in the specific account profile 214, an account score; and identifying, by a processing device (e.g., the processing unit 206), the specific content profile 210 based on a correspondence between the included at least one model score and the identified account score.

In step 516, at least the content item included in the specific content profile 210 may be transmitted, by a transmitting device (e.g., the transmitting unit 206), for distribution to the consumer 102. In one embodiment, each account profile 214 may further include a preferred method of distribution, and the content item included in the specific content profile 210 may be transmitted to the consumer 102 via the preferred method of distribution included in the specific account profile 214. In a further embodiment, the preferred method of distribution may be at least one of: e-mail, short message service, multimedia message service, and Internet website.

### Computer System Architecture

FIG. 6 illustrates a computer system 600 in which embodiments of the present disclosure, or portions thereof, may be implemented as computer-readable code. For example, the processing server 106 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 604 may be a special purpose or a general purpose processor device. The processor 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for distributing targeted content to a consumer. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing targeted content to a consumer, comprising:
storing, in a content database, a plurality of content profiles, wherein each content profile includes data relating to content for distributing including at least a content item and one or more selection criteria;
storing, in an account database, a plurality of account profiles, wherein each account profile includes data related to a payment account including at least an account identifier and a plurality of transaction data entries, each transaction data entry including transaction data corresponding to a payment transaction involving the related payment account;
storing, in a consumer database, a plurality of consumer profiles, wherein each consumer profile includes data related to a consumer including at least an account number and a transit identifier;
receiving, by a receiving device, a transaction notification, wherein the transaction notification corresponds to a transportation-related payment transaction involving a consumer and includes at least a specific transit identifier and a geographic location;
identifying, in the consumer database, a specific consumer profile where the included transit identifier corresponds to the specific transit identifier;
identifying, in the account database, a specific account profile where the included account identifier corresponds to the account number included in the specific consumer profile;
identifying, in the content database, a specific content profile based on the included one or more selection criteria and at least the transaction data included in the plurality of transaction data entries included in the specific account profile; and
transmitting, by a transmitting device, at least the content item included in the specific content profile for distribution to the consumer.

2. The method of claim 1, wherein the content item is at least one of: an advertisement, offer, deal, discount, or coupon for a good or service.

3. The method of claim 1, wherein the content item is at least one of: an e-mail, a short message service message, a multimedia message service message, and a digital image or video.

4. The method of claim 1, wherein each account profile further includes at least one of: demographic data, advertising data, offer data, and account-holder supplied data.

5. The method of claim 1, wherein each account profile does not include personally identifiable data.

6. The method of claim 1, wherein the identified specific content profile is further based on the geographic location included in the received transaction notification.

7. The method of claim 1, wherein the one or more selection criteria includes an associated geographic location.

8. The method of claim 1, wherein the one or more selection criteria includes at least one model score, and identifying the specific content profile further includes:
identifying, based on at least the transaction data included in each transaction data entry included in the specific account profile, an account score, and
identifying, by a processing device, the specific content profile based on a correspondence between the included at least one model score and the identified account score.

9. The method of claim 1, wherein each account profile further includes a preferred method of distribution, and the content item included in the specific content profile is transmitted to the consumer via the preferred method of distribution included in the specific account profile.

10. The method of claim 9, wherein the preferred method of distribution is at least one of: e-mail, short message service, multimedia message service, and Internet website.

11. A system for distributing targeted content to a consumer, comprising:
a content database configured to store a plurality of content profiles, wherein each content profile includes data relating to content for distributing including at least a content item and one or more selection criteria;
an account database configured to store a plurality of account profiles, wherein each account profile includes data related to a payment account including at least an account identifier and a plurality of transaction data entries, each transaction data entry including transaction data corresponding to a payment transaction involving the related payment account;
a consumer database configured to store a plurality of consumer profiles, wherein each consumer profile includes data related to a consumer including at least an account number and a transit identifier;
a receiving device configured to receive a transaction notification, wherein the transaction notification corresponds to a transportation-related payment transaction involving a consumer and includes at least a specific transit identifier and a geographic location;
a processing device configured to
identify, in the consumer database, a specific consumer profile where the included transit identifier corresponds to the specific transit identifier,
identify, in the account database, a specific account profile where the included account identifier corresponds to the account number included in the specific consumer profile, and
identify, in the content database, a specific content profile based on the included one or more selection criteria and at least the transaction data included in the plurality of transaction data entries included in the specific account profile; and
a transmitting device configured to transmit at least the content item included in the specific content profile for distribution to the consumer.

12. The system of claim 11, wherein the content item is at least one of: an advertisement, offer, deal, discount, or coupon for a good or service.

13. The system of claim 11, wherein the content item is at least one of: an e-mail, a short message service message, a multimedia message service message, and a digital image or video.

14. The system of claim 11, wherein each account profile further includes at least one of: demographic data, advertising data, offer data, and account-holder supplied data.

15. The system of claim 11, wherein each account profile does not include personally identifiable data.

16. The system of claim 11, wherein the identified specific content profile is further based on the geographic location included in the received transaction notification.

17. The system of claim 11, wherein the one or more selection criteria includes an associated geographic location.

18. The system of claim 11, wherein the one or more selection criteria includes at least one model score, and identifying the specific content profile further includes:
identifying, based on at least the transaction data included in each transaction data entry included in the specific account profile, an account score, and
identifying, by a processing device, the specific content profile based on a correspondence between the included at least one model score and the identified account score.

19. The system of claim 11, wherein each account profile further includes a preferred method of distribution, and the content item included in the specific content profile is transmitted to the consumer via the preferred method of distribution included in the specific account profile.

20. The system of claim 19, wherein the preferred method of distribution is at least one of: e-mail, short message service, multimedia message service, and Internet website.
